(19) United States
(12) Patent Application Publication
(10) Pub. No.: US 2026/0134802 A1
(43) Pub. Date: May 14, 2026

(54) MAGNETIC COLOR SWATCH APPARATUS WITH REMOVABLE ROTATABLE SWATCHES FOR FLEXIBLE HAIR COLOR SELECTION AND COMPARISON

(71) Applicant: Tamika Sturgis, Houston, TX (US)

(72) Inventor: Tamika Sturgis, Houston, TX (US)

(21) Appl. No.: 18/942,704

(22) Filed: Nov. 10, 2024

(51) Int. Cl. G09F 11/04

(52) U.S. Cl. CPC G09F 11/04

(57) ABSTRACT

The invention relates to a magnetic color swatch apparatus for selecting and comparing hair colors. The apparatus comprises a base with a central magnet and a plurality of circular swatches, each having a magnet at its center, allowing them to attach to the base and rotate freely by magnetic force. Each swatch has multiple brushes along its perimeter, with each brush representing a different shade of the color associated with the swatch. The brushes are labeled with the corresponding shade name to provide clear identification. The apparatus enables hairstylists and clients to compare colors side-by-side by rotating the swatches and customizing color palettes as needed. The durable materials ensure color accuracy and longevity, while the magnetic system allows for flexible arrangement of the swatches, making the apparatus ideal for dynamic color visualization in salon environments.

### CROSS REFERENCE TO RELATED APPLICATION

This application claims the benefit of U.S. Provisional Patent Application Ser. No. 63/656,849 entitled, “MAGNETIC COLOR WHEEL SWATCH”, filed Jul. 6, 2024, which is incorporated herein in its entirety.

### TECHNICAL FIELD

The present invention relates to hairdressing and hair coloring tools, specifically to a magnetic color wheel swatch used for displaying and comparing hair color options. More specifically, the present invention facilitates efficient organization, selection, and visualization of hair colors in salon settings.

### BACKGROUND OF THE INVENTION

In the hairdressing and hair coloring industry, the process of selecting the correct hair color is both essential and complex. Clients often rely on their hairstylist to make informed decisions regarding color choices, and the success of these decisions greatly influences customer satisfaction and overall salon efficiency. Traditionally, stylists have used physical swatch books or rings as tools to guide clients through the hair color selection process. These tools, however, come with several notable limitations that restrict their effectiveness in modern salon environments.

One significant issue with traditional color swatches is their inherent disorganization. These swatch systems typically involve a collection of small, individual swatches attached to a ring or bound in a book. Over time, these swatches can become disordered or misplaced, making it difficult for a stylist to quickly locate the specific color a client is interested in. This not only delays the consultation process but also leads to a cumbersome and frustrating experience for both the stylist and the client. In busy salons, where time is a critical resource, the inefficiency of locating and presenting colors directly impacts the number of clients that can be served in a given period.

Another major drawback of conventional swatch systems is their lack of flexibility and interactivity. In most cases, swatches are fixed in a rigid sequence, whether arranged by color family, numerical order, or another predefined structure. This fixed layout limits the ability to rearrange or compare multiple swatches in a practical way. In hairdressing, color selection is rarely a simple matter of choosing a single swatch; clients often wish to see how different shades complement each other, especially when considering highlights, lowlights, or blended color treatments. The inability to easily compare colors side by side or move swatches around to simulate blending significantly hampers the stylist's ability to provide the best recommendations. This leads to a less informed decision-making process, which can result in dissatisfaction if the final color does not meet the client's expectations.

Compounding these issues is the poor visualization provided by traditional color swatches. Hair color is rarely static; it changes with light, texture, and blending with other shades. Traditional swatch books or rings present colors in isolation, making it difficult for clients to understand how one color will interact with another when applied to their hair. Linear or ring-based swatch systems do not offer a natural way to visualize how colors blend or transition, which is a critical aspect of hair coloring. Without a way to simulate these interactions during the selection process, clients may struggle to imagine how the final result will appear. This can lead to inaccurate color choices, ultimately increasing the likelihood of dissatisfaction and requiring corrective treatments or reapplication.

Durability is another challenge inherent in traditional color swatches. Most swatch systems are made from paper, fabric, or other materials that degrade over time. These materials are prone to wear and tear from constant handling, and they often lose their color accuracy due to exposure to environmental conditions such as light, air, and the chemicals present in a salon environment. Fading, fraying, or discoloration of swatches means that the colors they represent may no longer accurately reflect the true shades that will be applied to the client's hair. This creates a significant risk for both the stylist and the client, as selecting a faded swatch could result in a color outcome that does not match the original intention. Over time, the degradation of these materials diminishes the usefulness of the swatches, requiring frequent replacement and adding unnecessary cost to the salon.

Existing color swatch systems also fail to engage the client in a meaningful, interactive experience. Clients today are increasingly looking for a more immersive and collaborative approach when it comes to choosing their hair color. Traditional swatch books and rings do not offer much opportunity for client involvement beyond simply looking at the available options. This passive experience can leave clients feeling disconnected from the decision-making process, potentially leading to indecision or uncertainty about their final color choice. A lack of engagement during the consultation can also place additional pressure on the stylist, who may have to spend more time explaining options or reassuring the client about their choices. In a fast-paced salon environment, this extra time can slow down operations and reduce overall productivity.

Furthermore, the static nature of traditional swatch systems does not easily accommodate updates or seasonal changes. Hair color trends evolve quickly, with new shades and tones being introduced regularly to match seasonal trends or celebrity influences. Traditional swatch books and rings are not designed for easy updates or customization, meaning that salons often struggle to keep their color offerings current. When a new line of shades is introduced, the salon may need to purchase an entirely new set of swatches or manually integrate new colors into the existing system, both of which can be costly and inefficient. Additionally, when older colors are discontinued, it can be difficult to remove their swatches from a bound or ring-based system, further contributing to disorganization and confusion.

In summary, traditional hair color swatch systems present several significant challenges for both stylists and clients. These systems are prone to disorganization, which slows down the consultation process and increases the likelihood of errors. Their inflexible structure limits the ability to compare and visualize colors dynamically, particularly when it comes to assessing how different shades will blend together in practice. The poor visualization offered by these systems makes it difficult for clients to accurately predict the final result, leading to potential dissatisfaction. Durability issues further undermine their reliability, as swatches lose their accuracy over time due to wear and exposure. Finally, the lack of interactivity and difficulty in updating traditional swatch systems leaves salons at a disadvantage when trying to engage clients and stay current with evolving trends.

As a result, there is a clear need for an innovative solution that addresses these shortcomings, providing a more organized, flexible, durable, and interactive approach to hair color selection in professional salons.

### SUMMARY OF THE INVENTION

In light of the disadvantages mentioned in the previous section, the following summary is provided to facilitate an understanding of some of the innovative features unique to the present invention and is not intended to be a full description. A full appreciation of the various aspects of the invention can be gained by taking the entire specification and drawings as a whole.

The present invention provides a magnetic color swatch apparatus designed to facilitate the selection and comparison of hair colors in salon environments. The apparatus comprises a base with a central magnet and a plurality of circular swatches, each having a central magnet that allows the swatches to rotate freely on the base through magnetic engagement. Each swatch features multiple brushes positioned around its perimeter, with each brush representing a distinct shade of the color associated with the swatch. To aid in precise color identification, each brush is labeled with the corresponding shade name.

The magnetic attachment system allows the swatches to be securely positioned on the base while still enabling rotation and easy rearrangement, facilitating the comparison of different colors side-by-side. The durable materials used in the construction of the swatches ensure long-lasting color accuracy, and the apparatus can withstand the demands of frequent use in salons. The system also allows for customization of color layouts, enabling salons to create personalized or seasonal color palettes by rearranging or replacing the swatches. The invention further improves consultation efficiency by allowing stylists and clients to dynamically visualize color combinations, blending, and interaction.

In addition to the apparatus, the invention encompasses a method for using the magnetic color swatch apparatus in hair color consultations. This method involves providing the swatch apparatus, attaching the circular swatches to the base via the central magnet, and rotating the swatches to align and compare various shades. The method allows for the rearrangement of swatches to create custom palettes and to visualize how colors will blend when applied side-by-side. This interactive and flexible approach offers significant improvements over traditional swatch systems, which are typically static and less adaptable to individual client needs.

The magnetic color swatch apparatus provides a more organized, durable, and flexible solution for hair color selection, enhancing both the stylist's and the client's experience by enabling easier comparison and better visualization of colors. Its interactive design, rotatable swatches, and the ability to customize layouts address the limitations of traditional color selection tools, making it a valuable tool in modern salon environments.

This summary is provided merely for purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

The abovementioned embodiments and further variations of the proposed invention are discussed further in the detailed description.

### BRIEF DESCRIPTION OF THE DRAWINGS

FIG. 1A is an exemplary top view of a circular swatch, showing the arrangement of cool tones. The swatches are attached to the base with a central magnet, allowing them to rotate freely for comparison.

FIG. 1B another exemplary top view of a circular swatch, showing the arrangement of red tones. The swatches are attached to the base with a central magnet, allowing them to rotate freely for comparison.

FIG. 2A another exemplary top view of a circular swatch, showing the arrangement of ash tones. The swatches are attached to the base with a central magnet, allowing them to rotate freely for comparison.

FIG. 2B another exemplary top view of a circular swatch, showing the arrangement of natural neutral tones. The swatches are attached to the base with a central magnet, allowing them to rotate freely for comparison.

FIG. 3A another exemplary top view of a circular swatch, showing the arrangement of natural tones. The swatches are attached to the base with a central magnet, allowing them to rotate freely for comparison.

FIG. 3B another exemplary top view of a circular swatch, showing the arrangement of natural ash tones. The swatches are attached to the base with a central magnet, allowing them to rotate freely for comparison.

FIG. 4A another exemplary top view of a circular swatch, showing the arrangement of gold tones. The swatches are attached to the base with a central magnet, allowing them to rotate freely for comparison.

FIG. 4B another exemplary top view of a circular swatch, showing the arrangement of gray coverage neutral tones. The swatches are attached to the base with a central magnet, allowing them to rotate freely for comparison.

FIG. 5A another exemplary top view of a circular swatch, showing the arrangement of red tones. The swatches are attached to the base with a central magnet, allowing them to rotate freely for comparison.

FIG. 5B another exemplary top view of a circular swatch, showing the arrangement of copper tones. The swatches are attached to the base with a central magnet, allowing them to rotate freely for comparison.

FIG. 6A another exemplary top view of a circular swatch, showing the arrangement of natural beige tones. The swatches are attached to the base with a central magnet, allowing them to rotate freely for comparison.

FIG. 6B another exemplary top view of a circular swatch, showing the arrangement of warm beige tones. The swatches are attached to the base with a central magnet, allowing them to rotate freely for comparison.

FIG. 7 is an exemplary top view of a plurality of swatches associated with different color shades attached on the base portion with brushes attached to the perimeter, focusing on the organization of the swatches and the magnetic attachment system.

The drawings described herein are for illustration purposes only and are not intended to limit the scope of the present subject matter in any way.

### DETAILED DESCRIPTION

In the following description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments maybe utilized and that changes may be made without departing from the scope of the present invention. The following detailed description is, therefore, not to be taken in a limited sense, and the scope of the present invention is defined only by the appended claims.

The specification may refer to “an”, “one” or “some” embodiment(s) in several locations. This does not necessarily imply that each such reference is to the same embodiment(s), or that the feature only applies to a single embodiment. A single feature of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the foregoing sections, some features are grouped together in a single embodiment for streamlining the disclosure. This method of disclosure is not to be interpreted as reflecting an intention that the disclosed embodiments of the present disclosure must use more features than are expressly recited in each claim. Rather, as the following claims reflect, the inventive subject matter lies in less than all features of a single disclosed embodiment. Thus, the following claims are hereby incorporated into the detailed description, with each claim standing on its own as a separate embodiment.

The hair coloring process in salons has long relied on traditional swatch systems such as books or rings to assist stylists and clients in selecting appropriate shades. While widely used, these systems suffer from several key drawbacks. As discussed earlier, traditional systems often become disorganized, lack interactivity, and fail to provide a clear visualization of how colors will interact and blend when applied. These limitations make it difficult for both the stylist and client to make informed decisions, leading to inefficiencies and sometimes dissatisfaction with the final result. Furthermore, the durability of traditional swatches is compromised due to their material composition, which tends to degrade over time from frequent use and exposure to salon environments.

The present invention, a magnetic color swatch apparatus, introduces a novel solution to the challenges associated with traditional hair color selection tools used in professional salons. This invention is designed to enhance the efficiency, flexibility, and accuracy of the hair color selection process by allowing hairstylists and clients to interactively compare, select, and visualize hair colors. The core components of the invention include a base with a central magnet, circular magnetic swatches, and a magnetic attachment system that together form an interactive, customizable, and durable tool for hair color consultations.

The base serves as the foundational component of the magnetic color swatch apparatus. The base has a circular layout and contains a central magnet embedded at its center. This magnet acts as the primary attachment point for the circular magnetic swatches, which are placed on top of the base. The interaction between the central magnet and the magnets embedded within the swatches allows the swatches to rotate freely on the base through magnetic force, enabling easy repositioning and comparison of colors. Unlike traditional swatch systems, the base is stationary, and the swatches can be rotated individually, providing 360-degree access to all the colors.

Each circular magnetic swatch has a magnet embedded at its center that aligns with the magnet in the base, allowing it to rotate smoothly on top of the base. The magnetic attachment system ensures that the swatches remain securely attached during use, while still allowing for easy removal and rearrangement as needed. The circular layout of the swatches is essential to the user experience, enabling stylists and clients to easily view and compare multiple colors side-by-side by rotating the swatches rather than flipping through a book of swatches. The swatches can be grouped and arranged in any order, making it easy to customize the layout based on the stylist's preferences or the client's needs.

Each circular swatch includes a plurality of brushes positioned along its perimeter. Each brush represents a distinct shade of the color associated with that swatch. The brushes are designed to simulate how different shades of a specific color will appear when applied, offering the stylist and client a more accurate representation of color variations. The brushes are made from durable, colorfast materials to ensure that they remain true to their represented colors over time, even with frequent handling and exposure to salon chemicals. The circular swatches are capable of holding several shades of a single color, making it easier to compare subtle variations in tone, hue, or undertone within the same color family.

Each brush is labeled with the corresponding shade name, which provides important information for both the stylist and the client during the color selection process. The labels are printed near each brush on the swatch itself, and in addition to the shade name, the label may include further details such as color codes or undertone characteristics. This labeling system ensures that both the stylist and client can easily identify the exact shade they are considering, and it helps maintain the organization of the swatches during the consultation. By providing key color information directly on the swatches, the labeling system improves efficiency and reduces the potential for confusion.

One of the main advantages of the magnetic attachment system is its ability to allow stylists to rearrange the swatches dynamically. This feature enables easy comparison of multiple colors by simply rotating the swatches next to each other on the base, allowing the user to see how different shades will interact when applied. For example, if a client is considering highlights or lowlights, the stylist can position the swatches representing the base color and highlight color side by side for comparison. The swatches can then be rotated to view additional color combinations. This interactivity provides the client with a more accurate visualization of how the colors will blend together, resulting in a more informed decision-making process.

The magnetic swatches are also constructed with durable materials that resist fading, discoloration, and wear. This ensures that the swatches retain their color accuracy over time, even with frequent use in a salon environment. The magnets embedded in the swatches and base are strong enough to hold the swatches securely in place during use, yet flexible enough to allow for easy removal and repositioning. The magnetic system ensures that the swatches can be easily updated or replaced as needed, allowing the salon to maintain an up-to-date color selection without the need for entirely new tools. Additionally, the magnets are configured to prevent accidental detachment during use, ensuring that the swatches remain securely attached even in busy, fast-paced salon environments.

The circular arrangement of the swatches enhances the ability to visualize how colors will blend. Unlike traditional linear or ring-based swatch systems, which only allow for a sequential display of colors, the circular arrangement offers a continuous view of color transitions. This makes it particularly useful when selecting multiple colors for treatments such as highlights, lowlights, balayage, or ombre, as the stylist can spin the swatches to see how the different shades will blend seamlessly together. The interactive design also reduces the time required for consultations, as the stylist can quickly rotate the swatches to show different color combinations without having to flip through swatch books or reposition the client's view.

The magnetic attachment system also contributes to the durability of the apparatus. Traditional swatch systems are often made from paper or fabric, which can degrade over time due to constant handling, exposure to light, and contact with salon chemicals. These materials are prone to fading, fraying, or tearing, making them less accurate and less reliable over time. In contrast, the magnetic swatches used in this invention are made from long-lasting, durable materials that resist wear and tear, ensuring their accuracy even after extensive use. The magnetic backing ensures that the swatches remain securely attached to the base, while allowing for flexibility in rearranging or replacing the swatches as needed. This durability makes the magnetic color swatch apparatus a cost-effective solution for salons, reducing the need for frequent replacement of tools.

The base of the apparatus is designed for stability and ease of use. It includes non-slip features or grip pads to ensure that it remains securely in place on salon surfaces such as countertops or styling stations. The design prevents the base from slipping or moving during use, even in fast-paced salon environments. Additionally, the magnetic attachment system allows the swatches to rotate freely without the need for mechanical components, making the tool simple and low-maintenance. The central magnet in the base ensures that the swatches remain aligned during rotation, and the non-slip base ensures that the apparatus stays stable throughout the consultation process.

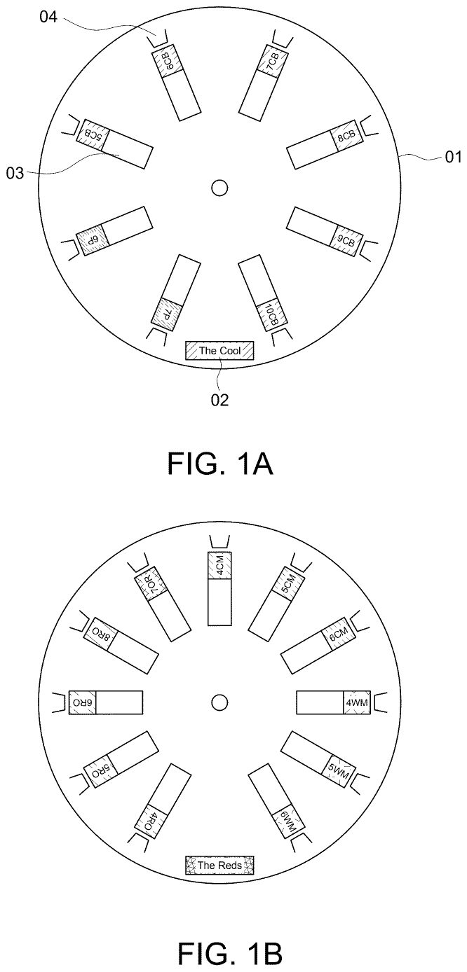

In FIG. 1A, the top view of the circular swatch (01) shows the arrangement of the cool tones (02) and red tones (03). The swatches are attached to the base (not shown) with a central magnet (not shown), allowing them to rotate freely for comparison. The swatches are arranged in a circular layout, with each tone corresponding to a specific label representing the color (02) and label representing the shade name (03) of each tone on the swatch (01). The slots for attaching the brushes (04) are visible along the perimeter of the swatch.

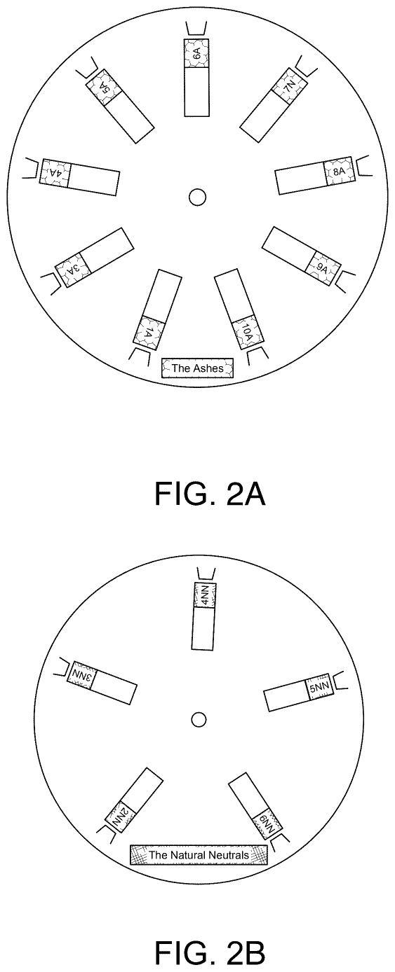

FIG. 2A shows an exemplary top view of a circular swatch, demonstrating the arrangement of ash tones. The swatches are attached to the base with a central magnet, allowing them to rotate freely for comparison. The brushes are arranged along the perimeter of the circular swatch. In FIG. 2B, another exemplary top view of a circular swatch shows the arrangement of natural neutral tones. The swatches are attached to the base with a central magnet, allowing for easy rotation during use.

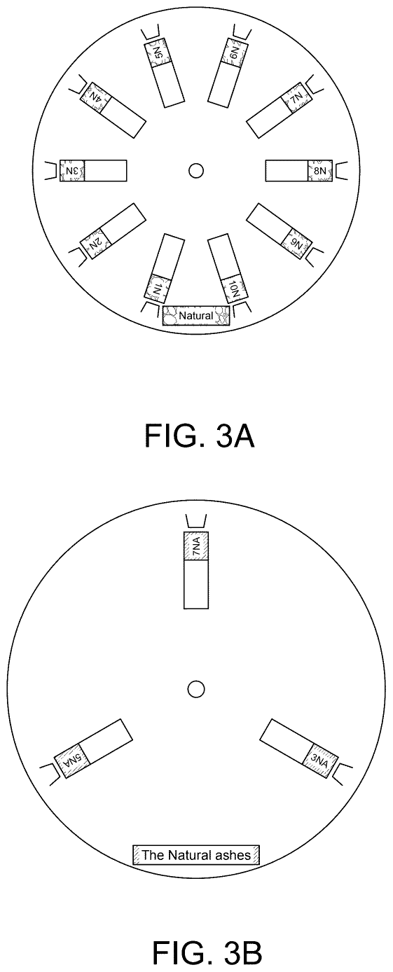

FIG. 3A illustrates another exemplary top view of a circular swatch, depicting the arrangement of natural tones. The swatches are secured with a central magnet, allowing for effortless rotation and comparison of different tones. FIG. 3B displays another exemplary top view of a circular swatch, focusing on the arrangement of natural ash tones. The central magnet keeps the swatches attached to the base, while allowing them to be rotated freely during color selection.

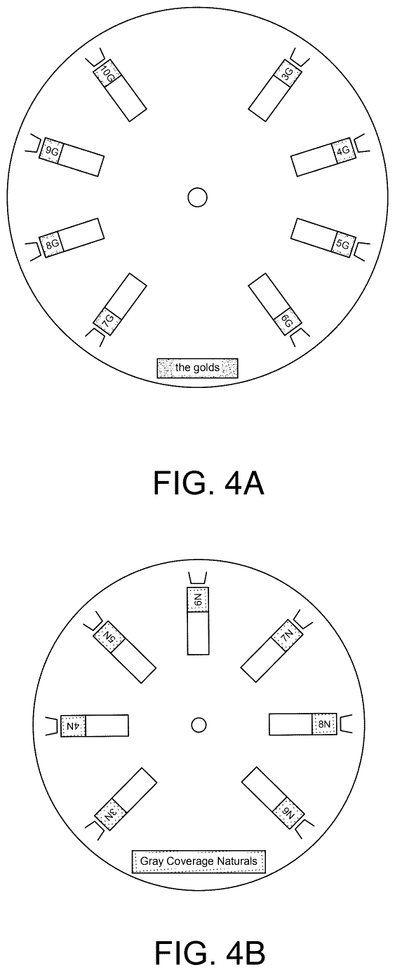

FIG. 4A presents an exemplary top view of a circular swatch, showing the gold tones arrangement. The swatches are securely attached to the base with a central magnet, enabling smooth rotation for color comparison. FIG. 4B offers an exemplary top view of a circular swatch, depicting the arrangement of gray coverage neutral tones. These swatches rotate freely for side-by-side comparison, secured with the central magnet.

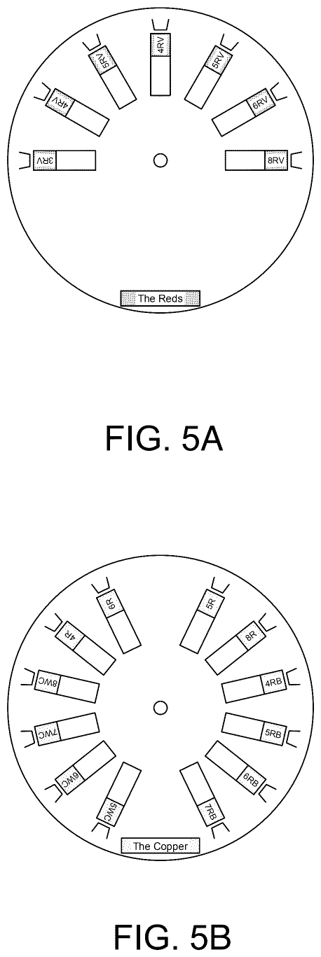

FIG. 5A illustrates another top view of a circular swatch, showing the arrangement of red tones. The swatches are attached to the base with a central magnet, which allows for flexible movement and alignment during consultations. FIG. 5B provides another top view of a circular swatch, showing the arrangement of copper tones. The swatches are connected to the base via a central magnet, allowing for fluid rotation and color comparison.

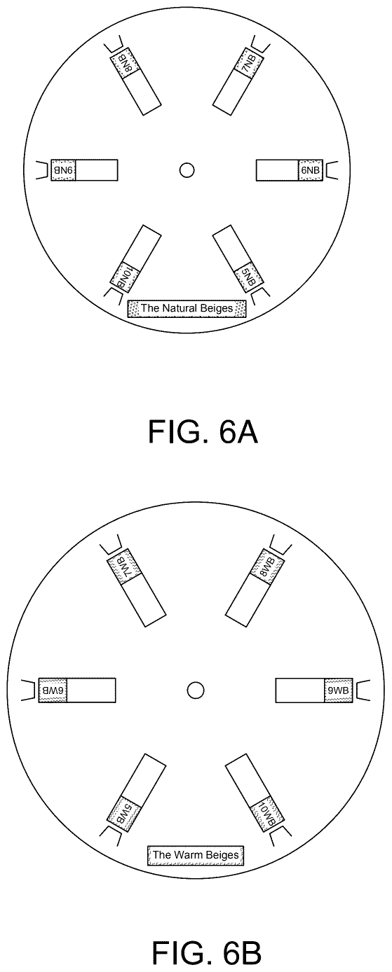

FIG. 6A illustrates another top view of a circular swatch, highlighting the arrangement of natural beige tones. These swatches, attached via a central magnet, allow easy rotation during client consultations for effective color visualization. FIG. 6B shows an exemplary top view of a circular swatch, focusing on the arrangement of warm beige tones. The swatches rotate smoothly on the base using the central magnet for flexibility and comparison.

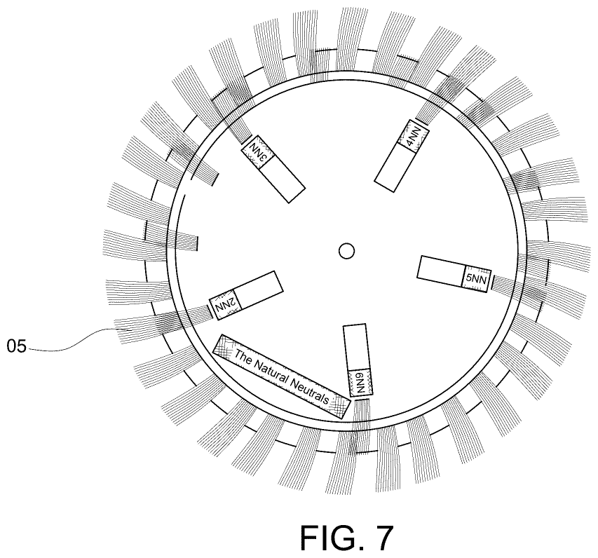

In FIG. 7, a top view of a plurality of swatches is provided, showing brushes (05) attached to the perimeter of each swatch. This figure highlights the organization of different color families and their associated shades, with the magnetic attachment system securing the swatches to the base. The brushes allow for easy application and demonstration of color blending, giving a clear visualization of how multiple tones interact when applied side-by-side.

The magnetic color swatch apparatus offers several key advantages over traditional swatch systems. First, the interactive nature of the tool allows for real-time customization of color layouts, enabling stylists to create personalized arrangements that cater to the specific needs of their clients. This flexibility is particularly beneficial for consultations involving multiple colors, as the circular swatches can be rotated and rearranged to easily compare and select complementary shades. Additionally, the magnetic attachment system ensures that the swatches remain securely in place during use, while still allowing for easy removal and repositioning. This feature greatly enhances the organization and functionality of the tool, reducing the time required for consultations and improving the overall user experience.

The durability of the magnetic color swatches and the base with the central magnet is another significant advantage. The use of high-quality materials ensures that the tool can withstand frequent use in a professional salon environment without degrading. The swatches are resistant to fading, discoloration, and wear, ensuring that they maintain their accuracy and reliability over time. This durability not only improves the long-term utility of the tool but also reduces the need for frequent replacement, making it a cost-effective solution for salons. The brushes on each swatch are constructed from durable, colorfast materials, ensuring they remain accurate representations of the shades they depict.

The adaptability of the magnetic color swatch apparatus extends beyond its primary use in hair color consultations. The tool is also valuable in training settings, where new stylists can practice selecting and comparing colors using a hands-on, interactive system. Additionally, hair color manufacturers and distributors can use the tool to showcase their product lines in an organized and visually engaging format. The modular nature of the swatch system allows for easy updates and customization, such as replacing swatches to match seasonal trends or introducing new color collections. This makes the apparatus suitable for use in other beauty-related industries, such as makeup or fashion design, where color selection plays a critical role.

In conclusion, the magnetic color swatch apparatus provides a significant improvement over traditional swatch systems by offering enhanced organization, flexibility, and durability. Its innovative design allows for more efficient and accurate hair color consultations, leading to higher client satisfaction and improved salon productivity. The tool's ability to adapt to changing trends and client needs ensures that it will remain a valuable asset for hairstylists and salons for years to come.

In addition to the circular configuration, the magnetic color swatch apparatus can also be adapted to other geometric designs, such as rectangular, triangular, or elliptical swatches, depending on the stylist's or manufacturer's preferences. In such configurations, the swatches would still include the magnetic backing for attachment to the base and the ability to rotate or be repositioned on the surface. The non-circular designs offer further customization options, allowing for unique presentations or arrangements of color families that might better suit particular consultation styles or client preferences. These alternative designs maintain the same core functionality as the circular swatches, ensuring secure attachment, durability, and ease of comparison, while providing additional flexibility in layout and presentation.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications, and changes may be made without departing from the spirit of the present solution. All the features disclosed in this specification (including any accompanying claims, abstract, and drawings), and all of the steps of any method or process so disclosed, may be combined in any combination, except combinations where at least some of such features or steps are mutually exclusive.

The terms “include,” “have,” and variations thereof, as used herein, have the same meaning as the term “comprise” or an appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A magnetic color swatch apparatus, comprising:
a base having a circular layout and a central magnet; and
a plurality of circular swatches, each having a magnet at its center, wherein the magnet of each swatch is configured to engage the central magnet of the base, allowing the swatches to rotate freely on the base, wherein each swatch includes a plurality of brushes disposed along its perimeter, each brush representing to a different shade of the color associated with the swatch, and wherein each brush is labeled with the shade name corresponding to the shade represented by that brush.

2. The magnetic color swatch apparatus of claim 1, wherein each swatch is made from durable materials to maintain color accuracy over time.

3. The magnetic color swatch apparatus of claim 1, wherein the base includes non-slip features to provide stability during use.

4. The magnetic color swatch apparatus of claim 1, wherein the magnets embedded in the swatches and base are configured to allow smooth rotation of the swatches with minimal friction.

5. The magnetic color swatch apparatus of claim 1, wherein the brushes are made of a colorfast synthetic material to ensure that the shades remain accurate despite frequent handling or exposure to salon chemicals.

6. The magnetic color swatch apparatus of claim 1, wherein the labels on each brush provide additional information including color codes or undertones for each shade.

7. The magnetic color swatch apparatus of claim 1, wherein the circular swatches are arranged into color families, allowing for easy identification and comparison.

8. The magnetic color swatch apparatus of claim 1, wherein the magnets are designed to prevent accidental detachment of the swatches from the base during use.

9. The magnetic color swatch apparatus of claim 1, wherein the base and swatches are resistant to salon chemicals and heat.

10. The magnetic color swatch apparatus of claim 1, wherein the rotation of the swatches allows for direct side-by-side comparison of shades on adjacent brushes.

11. The magnetic color swatch apparatus of claim 1, wherein the swatches are designed to be interchangeable, allowing for updated or seasonal color collections to be added to the base.

12. The magnetic color swatch apparatus of claim 1, wherein each swatch is configured with a central locking mechanism to prevent unintended movement while in use.

13. The magnetic color swatch apparatus of claim 1, wherein each swatch is provided with textured surfaces along its perimeter to aid in manual rotation of the swatch.

14. The magnetic color swatch apparatus of claim 1, wherein the base is configured with an indicator or alignment system to show the starting position of the swatches for consistent arrangement.

15. The magnetic color swatch apparatus of claim 1, wherein the brushes are detachable from the swatches, allowing for replacement or reconfiguration.

16. A method for selecting a hair color using a magnetic color swatch apparatus, comprising:
providing a magnetic color swatch apparatus comprising a base with a central magnet and a plurality of circular swatches, each swatch having a central magnet and a plurality of brushes representing different shades;
attaching the swatches to the base via the central magnet; and
rotating the swatches to align different brushes for comparison.

17. The method of claim 16, further comprising rearranging the swatches to create custom color palettes based on client preferences.

18. The method of claim 16, wherein the swatches are grouped by color family for easier identification and selection.

19. The method of claim 16, further comprising labeling each brush with color information for precise selection during the consultation process.

20. The method of claim 16, wherein the swatches are rotated to visualize how multiple shades blend together during side-by-side comparison.
